(19) United States
(12) Patent Application Publication
(10) Pub. No.: US 2014/0318483 A1
(43) Pub. Date: Oct. 30, 2014

(54) ENGINE

(71) Applicant: Martin Robert SHUTLAR, (US)

(72) Inventor: Martin Robert Shutlar, Woolooware (AU)

(21) Appl. No.: 14/363,580

(22) PCT Filed: Dec. 6, 2012
(86) PCT No.: PCT/AU2012/001480

§ 371 Date: Jun. 6, 2014

(30) Foreign Application Priority Data
Dec. 7, 2011 (AU) 2011253862

(51) Int. Cl. F02B 75/24

(52) U.S. Cl. CPC F02B 75/24; F02B 2075/1816
USPC 123/55.3

(57) ABSTRACT

An internal combustion engine includes a shaft and a multilobate central cam fixed to the shaft, the central cam having at least three lobes which define a central cam surface. There is at least one cylinder module, each cylinder module including a pair of cylinders. The cylinders are diametrically opposed with respect to the shaft with the central cam interposed therebetween. There is a piston in each cylinder, each piston including an associated engagement device for engaging the central cam surface and a connecting member connecting the pistons. The connecting member has an internal space through which the central cam extends. The reciprocating motion of the pistons in the cylinders in use imparts rotary motion to the shaft via engagement of the engagement device of the pistons with the central cam surface of the central cam.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to an engine.

The invention has been developed primarily for use in reciprocating piston engines and will be described hereinafter with reference to this application. However, it will be appreciated that the invention is not limited to this particular field of use.

2. Description of Related Art Including Information Disclosed Under 37 CFR 1.97 and 37 CFR 1.98.

A reciprocating piston engine, such as an internal combustion (or “IC”) engine, converts gas pressure into an output torque in a rotating shaft. Typically, in the case of the most common form of IC engine, a piston reciprocates in a bore of a cylinder due to the pressure exerted on the piston by the combustion of a fuel-air mixture. The piston is mechanically coupled to a crankshaft big end bearing by a connecting rod. The crankshaft big end bearing has an axis which is parallel to, but radially offset from, the rotational axis of the crankshaft, and thus axial forces acting on the piston are able to rotate and generate an output torque at the crankshaft. However, this mechanical arrangement of the piston, the connecting rod and the crankshaft is a substantial source of noise, wear and energy inefficiencies in typical IC engines.

To overcome some of the limitations and inefficiencies associated with this most common form of IC engines, PCT Publications WO 2008/028252 and WO 97/04225 disclosed replacing the crank shaft and connecting rod with multilobate cams counter-rotating about an axis, which has ameliorated some of the limitations and power inefficiencies of the prior IC engines.

The present invention seeks to provide improvements in the engines disclosed in WO 2008/028252 and WO 97/04225, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

In one aspect, the present invention provides an internal combustion engine comprising: a shaft; a multilobate central cam fixed to the shaft, the central cam comprising at least three lobes which define a central cam surface; at least one cylinder module, each cylinder module comprising: a pair of cylinders, the cylinders being diametrically opposed with respect to the shaft with the central cam interposed therebetween; a piston in each cylinder, each piston comprising an associated engagement means for engaging the central cam surface; and a connecting member connecting the pistons, the connecting member comprising an internal space through which the central cam extends; and wherein reciprocating motion of the pistons in the cylinders in use imparts rotary motion to the shaft via engagement of the engagement means of the pistons with the central cam surface of the central cam.

Preferably, the at least one cylinder module is two cylinder modules.

Preferably, the central cam comprises 3+n lobes where n is zero or an even-numbered integer; and the axes of the connecting members are at an angle to each other of substantially half of the number obtained by dividing 360[deg.] by the number of lobes on the central cam.

Alternatively, the at least one cylinder module is three or more cylinder modules.

Preferably, the internal combustion engine further comprises at least one multilobate lateral cam differentially geared to the central cam for counter rotation about the shaft.

Preferably, the at least one lateral cam is two multilobate lateral cams disposed on opposite sides of the central cam.

Preferably, the at least one lateral cam comprises a multilobate first lateral cam surface which is engaged by the corresponding engagement means associated with each piston.

Preferably, the at least one lateral cam comprises a multilobate second lateral cam surface axially spaced from the first lateral cam surface.

Preferably, both the first and second lateral cam surfaces are engaged by the corresponding engagement means associated with each piston. Preferably, the first and second lateral cam surfaces of the at least one lateral cam are defined by a multilobate recess formed in the at least one lateral cam.

Preferably, the at least one lateral cam comprises gear teeth.

Preferably, the internal combustion engine further comprises at least one drive gear fixed to the shaft, wherein the at least one lateral cam is differentially geared to the at least one drive gear.

Preferably, the engagement means associated with each piston comprises at least one roller bearing follower.

Preferably, the engagement means associated with each piston comprises at least one roller bearing follower disposed adjacent the internal space.

Preferably, the engagement means associated with each piston comprises at least one roller bearing follower disposed between the first and second lateral cam surfaces.

Preferably, the engagement means associated with each piston comprises a separate cam follower engaging a respective one of the first and second lateral cam surfaces.

Preferably, the connecting member comprises threaded end portions, and each piston comprises a threaded formation for attachment to a respective end portion of the connecting member.

Preferably, each piston comprises an attachment formation which defines the threaded formation.

Preferably, the threaded formation is an internal cavity formed in the attachment formation.

Preferably, the connecting member comprises an elongated aperture through which the shaft extends through.

Preferably, the connecting member is split into first and second longitudinal sections, wherein the first and second sections are held together by the pistons when the pistons are attached to end portions of the connecting member.

Preferably, the multilobate first cam surface is identical to the central cam surface. Preferably, the at least one lateral cam has the same number of lobes as the central cam, The present invention also provides an internal combustion engine comprising: a shaft; a multilobate central cam fixed to the shaft, the central cam comprising at least three lobes which define a central cam surface; two multilobate lateral cams disposed on opposite sides of the central cam, the lateral cams having the same number of lobes as the central cam, the lateral cams differentially geared to the central cam for counter rotation therewith about the shaft, each lateral cam defining a first lateral cam surface; two cylinder modules, each cylinder module comprising: a pair of cylinders, the cylinders being diametrically opposed with respect to the shaft with the central and lateral cams interposed therebetween; a piston in each cylinder, each piston comprising an associated engagement means for engaging the central cam surface and the first lateral cam surfaces; and a connecting member connecting the pistons, the connecting member comprising an internal space through which the central cam extends; and wherein reciprocating motion of the pistons in the cylinders in use imparts rotary motion to the shaft via engagement of the engagement means of the pistons with the cam surfaces of the central and lateral cams. Preferably, the two lateral cams each further comprises a second lateral cam surface axially spaced from the first lateral cam surface, wherein both first and second lateral cam surfaces are engaged by the corresponding engagement means associated with each piston.

Preferably, the engagement means associated with each piston comprises a separate cam follower engaging a respective one of the first and second lateral cam surfaces.

Preferably, the central and lateral cams comprise 3+n lobes where n is zero or an even-numbered integer; and the axes of the connecting members are at an angle to each other of substantially half of the number obtained by dividing 360[deg.] by the number of lobes on the central multilobate cam. Preferably, the two lateral cams each comprise gear teeth. Preferably, the internal combustion engine further comprises two drive gears fixed to the shaft and disposed adjacent a respective lateral cam, wherein the lateral cams are differentially geared to the drive gears.

The present invention also provides an internal combustion engine comprising: a shaft; at least two cylinder banks, each cylinder bank comprising: a multilobate central cam fixed to the shaft, the central cam comprising at least three lobes which define a central cam surface; at least one cylinder module, each cylinder module comprising: a pair of cylinders, the cylinders being diametrically opposed with respect to the shaft with the central cam interposed therebetween; a piston in each cylinder; and a connecting member connecting the pistons, a coupling cam disposed between each bank, each coupling cam differentially geared to the central cams for counter rotation about the shaft, each coupling cam defining a multilobate first coupling cam surface on each of opposing sides thereof; wherein each piston comprises an associated engagement means for engaging the central cam surface and a first coupling cam surface of its adjacent coupling cam; wherein reciprocating motion of the pistons in the cylinders in use imparts rotary motion to the shaft via engagement of the engagement means of the pistons with the central cam surfaces and the first coupling cam surfaces.

Preferably, each connecting member comprises an internal space through which the respective central cam extends; Preferably, the at least one cylinder module in each bank is two cylinder modules.

Preferably, each central cam comprises 3+n lobes where n is zero or an even-numbered integer; and the axes of the connecting members in each bank are at an angle to each other of substantially half of the number obtained by dividing 360[deg.] by the number of lobes on the central cam. Preferably, the internal combustion engine further comprises a multilobate lateral cam for each endmost bank, the lateral cams differentially geared to the central cams for counter rotation about the shaft.

Preferably, each lateral cam comprises a multilobate first lateral cam surface which is engaged by the engagement means of the respective piston.

Preferably, each lateral cam further comprises a second lateral cam surface axially spaced from the first lateral cam surface, wherein both the first and second lateral cam surfaces are engaged by the corresponding engagement means associated with the respective piston.

Preferably, the engagement means associated with each piston comprises a separate cam follower engaging a respective one of the first and second lateral cam surfaces.

Preferably, the opposing sides of each coupling cam comprises a second multilobate coupling cam surface axially spaced from the first coupling cam surface, wherein both the first and second coupling cam surfaces are engaged by the corresponding engagement means associated with the respective piston.

Preferably, the engagement means associated with each piston comprises a separate cam follower engaging a respective one of the first and second coupling cam surfaces

Preferably, the first coupling cam surfaces on opposite sides of the coupling cam are axially out of phase with each other by 60[deg.].

Preferably, the first coupling cam surfaces on opposite sides of the coupling cam are aligned with each other.

Preferably, each coupling cam comprises gear teeth. Preferably, each lateral cam comprises gear teeth.

Preferably, the internal combustion engine further comprises a drive gear for each endmost bank, the drive gears fixed to the shaft, wherein each coupling cam is differentially geared to the drive gears.

Preferably, the engagement means associated with each piston comprises at least one roller bearing follower.

Preferably, the banks are phased inline at 0[deg.] to each other or out of phase by any angle The present invention also provides an internal combustion engine comprising: a shaft; a first lateral cam fixed to the shaft; a second lateral cam differentially geared to the first lateral cam for counter-rotation about the shaft; wherein the first and second lateral cams each comprise a multilobate recess defining a multilobate internal cam surface and a multilobate external cam surface; at least one cylinder module, each cylinder module comprising: a pair of cylinders, the cylinders being diametrically opposed with respect to the shaft with the lateral cams interposed therebetween; a piston in each cylinder, each piston comprising an associated engagement means for engaging the internal and external cam surfaces of the lateral cams; and a connecting member connecting the pistons; and wherein reciprocating motion of the pistons in the cylinders in use imparts rotary motion to the shaft via engagement of the engagement means of the pistons with the internal and external cam surface of the lateral cams.

Preferably, the engagement means associated with each piston comprises a separate cam follower engaging a respective one of the internal and external lateral cam surfaces The present invention also provides a piston assembly for an engine comprising diametrically opposed cylinders, the piston assembly comprising: an elongated connecting member comprising threaded end portions, and two pistons, each piston comprising a threaded formation for attachment to a respective end portion of the connecting member in use. Preferably, the connecting member further comprises a central portion which defines an internal space through which a cam extends in use.

Preferably, the connecting member further comprises a central portion which defines an elongated aperture through which a shaft can extend through in use. Preferably, the connecting member further comprises an engagement means mounting recesses adjacent ends of the internal space.

Preferably, each piston comprises an attachment formation which defines the threaded formation.

Preferably, the threaded formation is an internal cavity formed in the attachment formation.

Preferably, the connecting member is split into first and second longitudinal sections, wherein the first and second sections are held together by the pistons when the pistons are attached to the end portions.

Preferably, each end portion of the connecting member and each attachment formation of the pistons comprises an attachment aperture, the assembly further comprising at least two mounting pins each respectively insertable in aligned attachment apertures of the connecting member and the pistons.

The present invention also provides a piston assembly for an engine comprising diametrically opposed cylinders, the piston assembly comprising: an elongated connecting member comprising end portions, and two pistons, each piston adapted for attachment to a respective end portion of the connecting member; wherein the connecting member is split into first and second longitudinal sections, wherein the first and second sections are held together by the pistons when the pistons are attached to the end portions.

Preferably, the end portions of the connecting member are threaded; and each piston comprises a threaded formation for attachment to a respective end portion of the connecting member.

Preferably, the connecting member defines a central portion having an internal space when the first and second longitudinal sections are attached to each other.

Preferably, the connecting member defines engagement means mounting recesses adjacent ends of the internal space when the first and second longitudinal sections are attached to each other. Preferably, each end portion of the connecting member and each piston comprises an attachment aperture, the assembly further comprising at least two mounting pins each respectively insertable in aligned attachment apertures of the connecting member and the pistons.

The present invention also provides a cam for an engine, the cam comprising: a generally disc-shaped body comprising a first face and a second face; and a multilobate recess formed in the first face and/or the second face, each multilobate recess defining a multilobate internal cam surface and a multilobate external cam surface.

Preferably, the cam further comprises gear teeth.

Other aspects of the invention are also disclosed.

### BRIEF DESCRIPTION OF THE DRAWINGS

Notwithstanding any other forms which may fall within the scope of the present invention, preferred embodiments of the present invention will now be described, by way of examples only, with reference to the accompanying drawings.

FIG. 1 is a side cross-section view (along one cylinder module) of internal components of an engine in accordance with a first preferred embodiment of the present invention.

FIG. 2 is a front elevation view of the engine of FIG. 1 with the front drive gear and the front trilobate cam gear removed.

FIG. 3 is an exploded cross-sectional view of the engine of FIG. 1.

FIG. 4 shows a drive gear for the engine of FIG. 1 where (a) is a front elevation view and (b) is a cross-section view along line A-A.

FIG. 5 shows a trilobate cam gear for the engine of FIG. 1 where (a) is a front elevation view and (b) is a cross-section view along line B-B.

FIG. 6 shows a first piston assembly for the engine of FIG. 1, where (a) is an exploded front elevation view, (b) is a side cross-section view of the connecting member, and (c) is a part side cross-section view of the assembled first piston assembly.

FIG. 7 shows a connecting member for a second piston assembly for the engine of FIG. 1, where (a) is a front elevation view, and (b) is a side cross-section view along line B-B.

FIG. 8 shows a trilobate central cam for the engine of FIG. 1 where (a) is a front elevation view and (b) is a cross-section view along line D-D.

FIG. 9 is a front elevation view of an example of a differential gear assembly for coupling the drive gears and the cam gears of the engine of FIG. 1.

FIG. 10 is a side cross-section view of internal components of an engine in accordance with a second preferred embodiment of the present invention.

FIG. 11 shows a double sided coupling cam gear for the engine of FIG. 10 where (a) is a front elevation view, (b) is a cross-section view along line E-E and (c) is a rear view.

FIG. 12 is a side cross-section view of a modified embodiment of the engine of FIG. 10.

FIG. 13 shows a modified double sided coupling cam gear for the engine of FIG. 12 where (a) is a front elevation view, (b) is a cross-section view along line C-C and (c) is a rear view.

FIG. 14 (a) is a side cross-section view of internal components of an engine in accordance with a third preferred embodiment of the present invention, and (b) shows a sectional view of a modified embodiment thereof.

FIG. 15 (a) is a side cross-section view of internal components of an engine in accordance with a fourth preferred embodiment of the present invention, and (b) shows a sectional view of a modified embodiment thereof.

### DETAILED DESCRIPTION OF THE DRAWINGS

It should be noted in the following description that like or the same reference numerals in different embodiments denote the same or similar features.

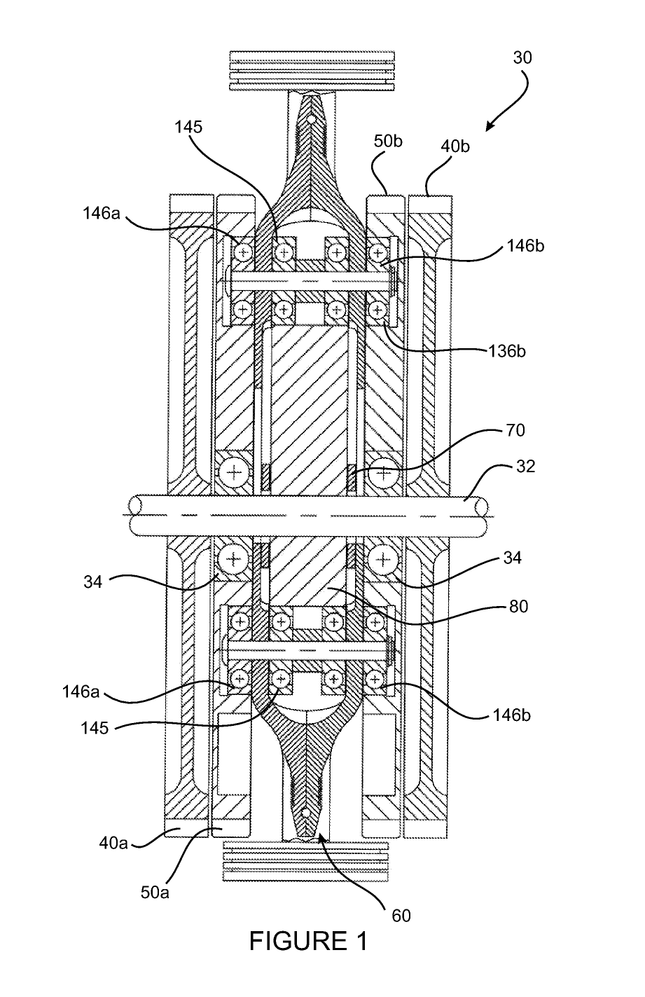

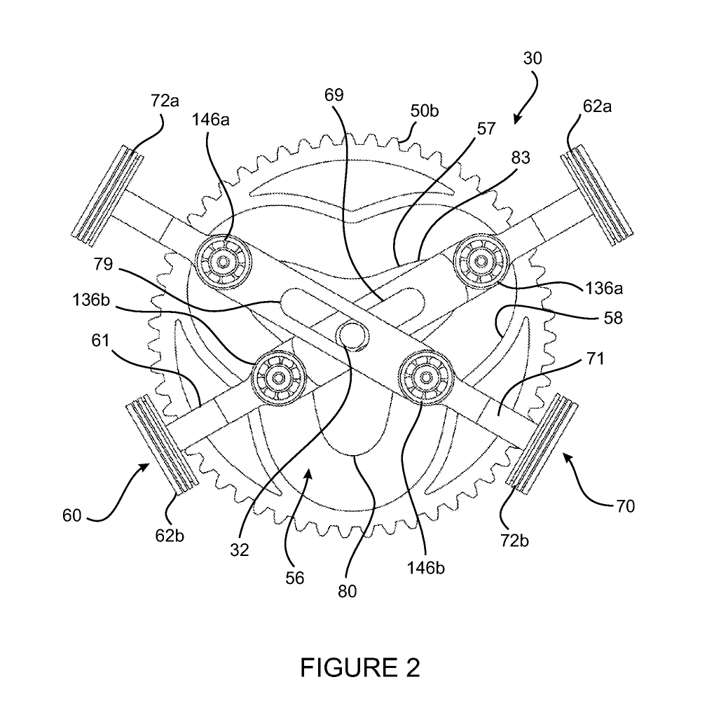

Referring initially to FIGS. 1 and 2, there is shown therein the internal components of a four cylinder four stroke engine 30. The outer engine casing, which includes two pairs of opposed cylinders, has been omitted so that the internal components can be seen clearly.

The engine 30 comprises an output shaft 32, a front drive gear 40a, a front cam gear 50a, first and second piston assemblies 60 and 70, a trilobate central cam 80, a rear cam gear 50b and a rear drive gear 40b. As further described below, the drive gears 40a and 40b and the central cam 80 are all axially fixed to the shaft 32 and rotatable therewith, whilst the cam gears 50a and 50b are rotatable around and in an opposite direction to the shaft 32. A differential gearing assembly (described below) couples the drive gears 40a and 40b and cam gears 50a and 50b together. Each of the first and second piston assemblies 60 and 70 (further described below) generally comprises a respective elongated connecting member 61, 71 with pistons 62a and 62b, 72a and 72b attached to ends of the respective connecting members 61 and 71. The axes of the first and second piston assemblies 60 and 70 are at a 60[deg.] angle relative to each about the shaft 32.

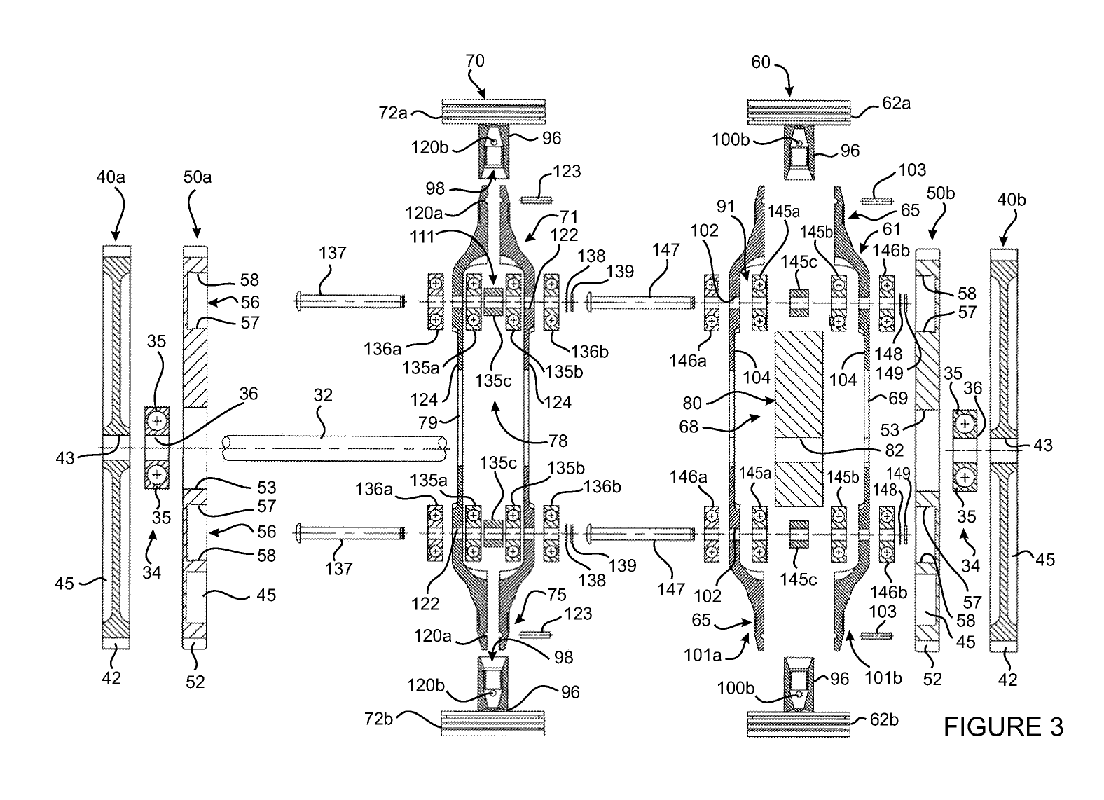

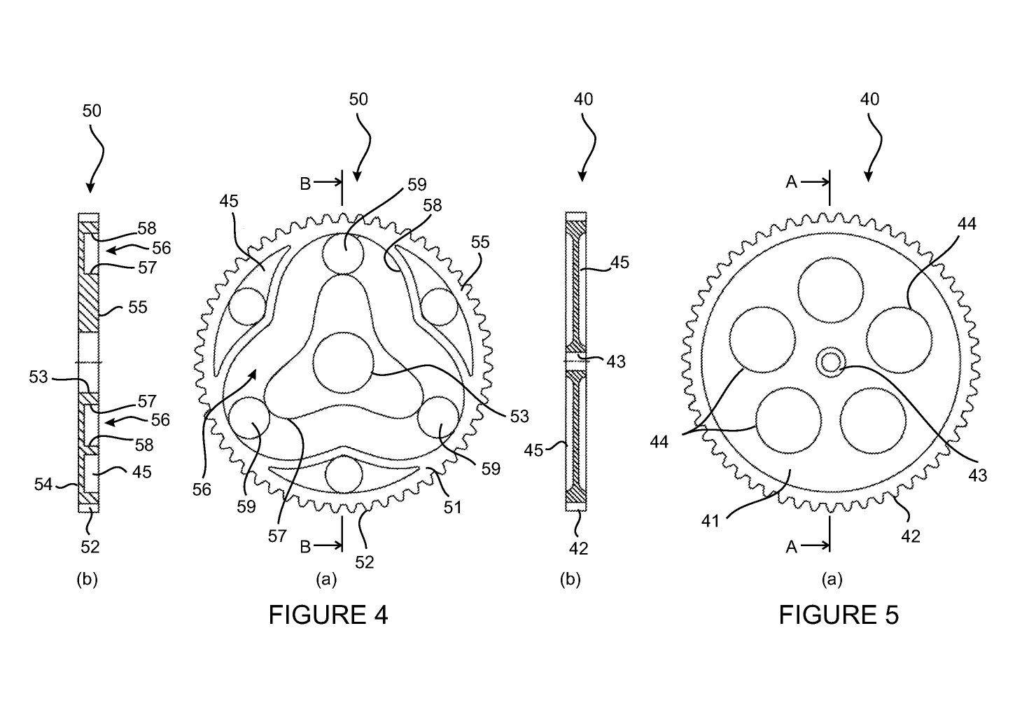

FIGS. 3 and 4 show a drive gear 40 which is a spur gear having a body 41, external teeth 42 and a central aperture 43. The central aperture 43 is keyed or splined for mating and rotating with the shaft 32. The body 41 can include apertures 44 and/or recesses 45 to lighten/balance its weight as desired. Two drive gears 40 respectively form the front and rear drive gears 40a and 40b of the engine 30.

FIGS. 3 and 5 show a cam gear 50 which is also generally a spur gear having a body 51, external teeth 52 and a central aperture 53. The central aperture 53 is adapted to receive and mount a roller bearing 34 therein. The body 51 include a first face 54 and a second face 55. A trilobate recess 56 is formed in the body 51 which generally extends from the second face 55 toward the first face 54. The trilobate recess 56 defines a (first) trilobate internal cam surface 57 and a (second) trilobate external cam surface 58. The second recess 58 is thus axially spaced from the first recess 57. The body 51 can also include apertures 59 and/or recesses 45 to lighten/balance its weight as desired. Two cam gears 50 respectively form the front and rear cam gears 50a and 50b of the engine 30. The front and rear cam gears 50a and 50b are arranged such that they mirror each other. Each bearing 34 includes an outer race 35 mounted to the aperture 53 of its respective cam gear 50, and an inner race 36 mounted to the shaft 32. The cam gears 50a and 50b can thus rotate in the opposite direction to the shaft 32. The cam gears 50a and 50b and drive gears 40a and 40b have the same external diameter.

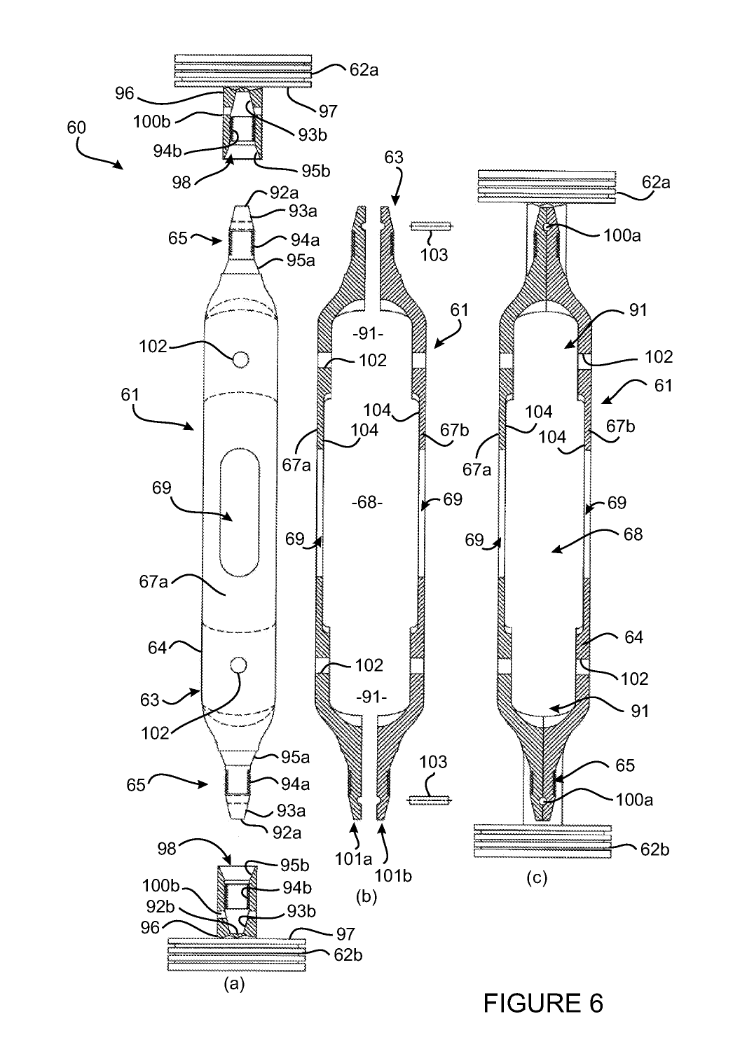

FIGS. 3 and 6 show the first piston assembly 60 which comprises the connecting member 61 and pistons 62. The connecting member 61 includes an elongated body 63 having a central portion 64 and end portions 65. As shown in FIG. 6(c), the central portion 64 includes first and second central plates 67a and 67b, which are spaced from each other to define a space 68 therebetween. As shown in FIG. 6(a), the first and second central plates 67a and 67b both comprise an elongated oval aperture 69 through which the shaft 32 extends in use, which allows the first piston assembly 60 to reciprocate along its longitudinal axis. The first and second central plates 67a and 67b also each include an elongated internal recess 104 formed therein which faces the space 68. Bearing mounting recesses 91 are formed in the central portion 64, at the ends of the space 68. Bearing mounting holes 102 are formed with the mounting recesses 91, the axes of the mounting holes 102 being parallel to the longitudinal axis of the shaft 32. The space 68 is thus open in a direction perpendicular to these axes.

The end portions 65 comprise a distal end 92a, a first tapered portion 93a, a cylindrical threaded portion 94a and a second tapered portion 95a. The end portion 65 also includes a mounting pin aperture 100a. The pistons 62 each comprise an attachment formation 96 extending from its non-combustion facing surface 97. Each attachment formation 96 includes an internal cavity 98 shaped to correspond to that of the end portions 65. The internal cavity 98 thus includes a distal end 92b, a first tapered portion 93b, a cylindrical threaded portion 94b and a second tapered portion 95b. Each attachment formation 96 also includes a mounting pin aperture 100b.

As shown in FIG. 6(b), the connecting member body 63 is split into first and second identical sections 101a and 101b, along a plane aligned with the longitudinal axis of the body 63 and perpendicular to the axes of the bearing mounting holes 102 and the shaft 32. The first and second sections 101a and 101b thus include a respective one of the central plates 67a and 67b. The first and second sections 101a and 101b are held together by the pistons 62 when the pistons 62 are attached to the end portions 65. The mating first tapered portions 93a and 93b, threaded portions 94a and 94b and second tapered portions 95a and 95b, together with the aligned mounting pin apertures 100a and 100b through which a mounting pin 103 is mounted, ensures that the first and second sections 101a and 101b are held to each other. When assembled, the central plates 67a and 67b define the space 68 therebetween and the bearing mounting recesses 91 are defined. The body 63 is split into the first and second sections 101a and 101b such that the connecting member 71 of the second piston assembly 70 can be disposed in the space 68 during assembly, as further described below.

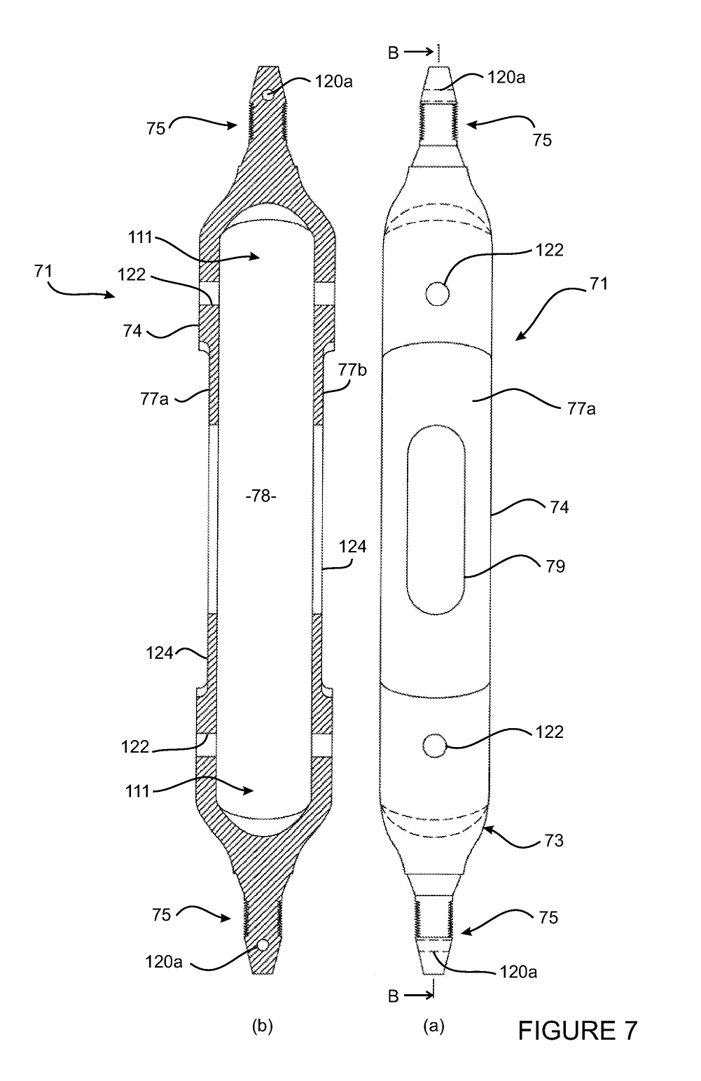

FIGS. 3 and 7 show the second piston assembly 70 which comprises the connecting member 71 and pistons 72. The connecting member 71 is similarly shaped as the connecting member 61 and includes an elongated body 73 having a central portion 74 and end portions 75. The central portion 74 includes first and second central plates 77a and 77b, which are spaced from each other to define a space 78 therebetween. The first and second central plates 77a and 77b also each include an elongated external recess 124 formed therein which faces away from the space 78. The first and second central plates 77a and 77b both comprise an elongated oval aperture 79 through which the shaft 32 extends in use, which allows the second piston assembly 70 to reciprocate along its longitudinal axis. Bearing mounting recesses 111 are formed in the central portion 74, at the ends of the space 78. Bearing mounting holes 122 are formed with the mounting recesses 111, the axes of the mounting holes 122 being parallel to the longitudinal axis of the shaft 32. The space 78 is thus open in a direction perpendicular to these axes. The end portions 75 are shaped similar to the end portions 65 and include a mounting pin aperture 120a. The pistons 72 are identical to the pistons 62 and comprise the attachment formation 96 with the internal cavity 98. The attachment formations 96 also include a mounting pin aperture 120b. When the pistons 72 are attached to the end portions 75, a mounting pin 123 is mounted into the aligned mounting pin apertures 120a and 120b. The connecting member body 73 can be formed as a single body (as shown in FIG. 7) or it can be split into first and second identical sections along its longitudinal axis similar to the connecting member body 63 (as shown in FIG. 3).

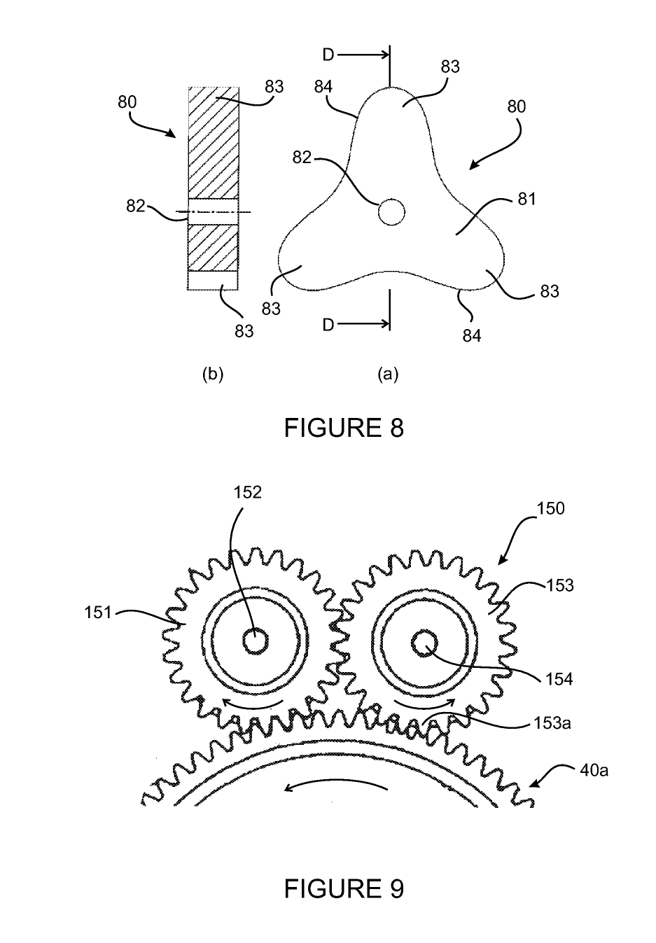

FIGS. 3 and 8 show the trilobate central cam 80 which includes a generally disc shaped body 81 having a central aperture 82 and three lobes 83. The central aperture 83 is keyed or splined for mating and rotating with the shaft 32. The lobes 82 are equiangularly spaced about the axis of the shaft 32, and define a peripheral cam surface 84. The cam surface 84 is identical to the internal cam surface 57 of the cam gear 50.

Assembly of the engine 10 will now be described primarily with reference to FIGS. 1 to 3. For the second piston assembly 70, a central bearing pair 135 is disposed within each bearing mounting recess 111 and lateral bearings 136a and 136b are disposed adjacent opposite external surfaces of the central portion 74. The bearing pair 135 comprises bearings 135a and 135b with a spacer 135c therebetween. The apertures of the bearings 135, 136a and 136b are aligned with the respective bearing mounting holes 122 and a lock pin 137 is inserted therethrough and locked via a washer 138 and circlip 139 or other suitable means as desired. The central cam 80 is then inserted into the space 78. The bearings 135 are dimensioned such that they are in constant engagement with the central cam surface 84.

The first piston assembly 60 is then assembled by disposing the first and second sections 101a and 101b on either side of the connecting member 71 of the second piston assembly 70. Each internal recess 104 thus faces and engages a corresponding external recess 124.

When the first and second sections 101a and 101b are attached to each other via the pistons 62, the bearing mounting recesses 91 are formed. A central bearing pair 145 is disposed within each bearing mounting recess 91 and lateral bearings 146a and 146b are disposed adjacent opposite external surfaces of the central portion 64. The bearing pair 145 comprises bearings 145a and 145b with a spacer 145c therebetween. The apertures of the bearings 145, 146a and 146b are aligned with the respective bearing mounting holes 102 and a lock pin 147 is inserted therethrough and locked via a washer 148 and circlip 149.

The central cam 80 is thus also located within the space 68 and engages the bearings 145, in addition to engaging the bearings 135. When the pistons 62 and 72 are disposed within their respective cylinders (not shown) to form the respective cylinder modules, the piston assemblies 60 and 70 form an X configuration as shown in FIG. 2, with an angle of 60[deg.] therebetween about the shaft 32.

The shaft 32 is then inserted into the aperture 82 of the central cam 80 for co-rotation therewith. The cam gears 50a and 50b, each having the bearing 34 are then disposed on opposite sides of the first and second piston assemblies 60 and 70 and the central cam 80. The inner race 36 of the bearings 34 are mounted to the shaft 32.

The lateral bearings 136a and 146a of the first and second piston assemblies 60 and 70 are disposed within the trilobate recess 56 of the cam gear 50a. The bearings 136a and 146a and/or the recess 56 are dimensioned such that the bearings are in constant engagement with both the trilobate internal cam surface 57 and the trilobate external cam surface 58. Similarly, the lateral bearings 136b and 146b of the first and second piston assemblies 60 and 70 are disposed within the trilobate recess 56 of the cam gear 50b. The drive gears 40a and 40b are then disposed adjacent the respective cam gear 50a and 50b and mounted to the shaft 32 for co-rotation therewith.

Each piston thus has associated engagement means, being the bearings for engaging the cam surfaces of the central cam and the (lateral) cam gears.

As described, the drive gears 40a and 40b and the central cam 80 are all axially fixed to the shaft 32 and rotatable therewith, whilst the cam gears 50a and 50b are rotatable around and in an opposite direction to the shaft 32. FIG. 9 shows an example of a differential gearing assembly 150 which couples the drive gear 40a, cam gear 50a, drive gear 40b and cam gear 50b together. The differential gearing assembly 150 comprises a first gear 151 rotatable about a first axle 152. The first gear 151 for example engages the drive gear 40a. The first gear 151 engages a second gear 153 which is rotatable about a second axle 154. The second gear 153 does not engage the drive gear 40a and is wider than the first gear 151, such that the second gear 153 engages the cam gear 50a at lower portions thereof generally indicated as 153a. For example, if the drive gear 40a is rotating counter clockwise (CCW) in FIG. 9, the first gear 151 will rotate clockwise (CW), the second gear 153 will rotate counter clockwise (CCW), and the cam gear 50a will rotate clockwise (CW). Thus, the drive gear 40a and the cam gear 50a will rotate in opposite directions. To couple the drive gears 40a and 40b and cam gears 50a and 50b together, the second gear 153 can be made wider to engage both cam gears 50a and 50b and the first axle 152 can include an additional gear which engages the second drive gear 40b and the second gear 153. It will be appreciated that there are numerous suitable differential gearing assemblies possible for coupling the drive gears 40a and 40b and cam gears 50a and 50b together, such that the drive gears 40a and 40b rotate together, and the cam gears 50a and 50b also rotate together but in the opposite direction to the drive gears 40a and 40b. Thus, the central cam 80 is indirectly coupled to the cam gears 50a and 50b for counter-rotation therewith. The differential gearing assembly 150 can also be utilised to remove or minimise gear backlash in the coupled drive gears and cam gears.

Operation of the engine 30 will now be described. The piston assemblies 60 and 70 are part of respective cylinder modules, wherein each of the pistons 62 and 72 are disposed in respective cylinders comprising fuel injection means, inlet and outlet valves and ignition means as is known. The drive gears 40a and 40b can include formations, such as gears, lobes or ramps, for engaging the inlet and outlet valves directly or a camshaft as desired.

In a four-stroke engine, the four strokes (at Top Dead Centre (TDC) and Bottom Dead Centre (BDC)) are generally as follows:

Piston at TDC finishing the exhaust stroke and entering the intake stroke; Piston at BDC finishing the intake stroke and entering the compression stroke;

Piston at TDC finishing the compression stroke and starting the power stroke; and

Piston at BDC finishing the power stroke and entering the exhaust stroke.

In one example, in the engine 30, when the piston 72a is at stroke (a), piston 62a is stroke (c), piston 62b is at stroke (b) and piston 72b is at stroke (d). The firing sequence in this example is piston 62a, piston 62b, piston 72a then piston 72b. Firing in one piston thus corresponds to the compression stroke in its opposite piston. Alternatively, the engine 30 can be a two-stroke engine with the opposing pistons firing alternately. The firing in the cylinders and the engagement between the bearings 135, 136, 145 and 146 and the cam surfaces 83, 57 and 58 provides the reciprocating motion of the first and second piston assemblies 60 and 70. The cam gears 50a and 50b rotate together and counter-rotate relative to the central cam 80. Thus, during the power stroke, all the bearings in each of the first and second piston assemblies 60 and 70 engage and translate force onto the cam surfaces 83, 57 and 58 to rotate the shaft 32. The same cam surfaces 83, 57 and 58 engage the other bearings in the compression and exhaust strokes of the pistons with a scissor like action. Power from the shaft 32 can then be utilised as desired.

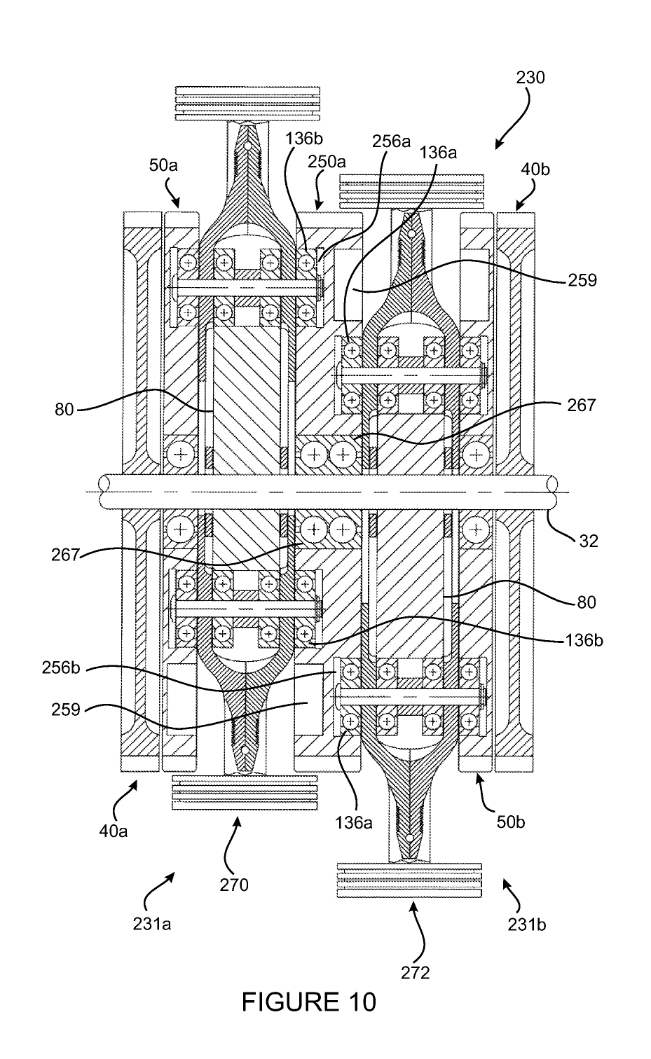

FIG. 10 shows an engine 230 in accordance with a second preferred embodiment of the present invention. Engine 230 is substantially two banks 231a and 231b of the engine 30 side by side. To couple the banks 231a and 231b, a coupling cam gear 250a is used.

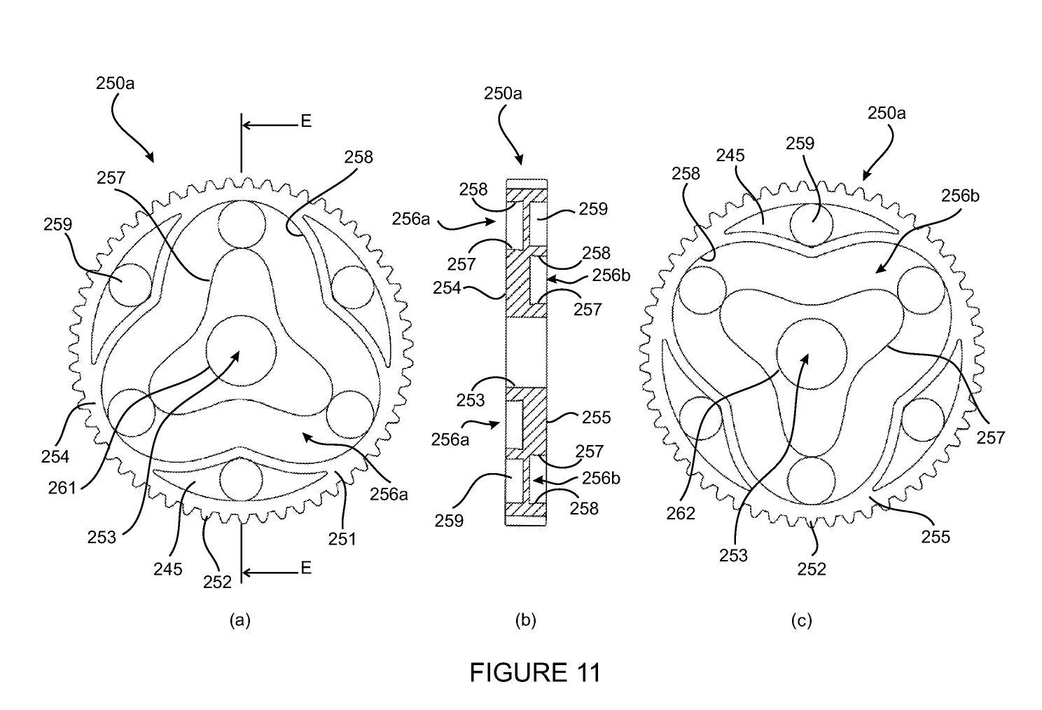

FIGS. 10 and 11 show the coupling cam gear 250a which is also generally a spur gear having a thick body 251, external teeth 252 and a central aperture 253. The body 251 include a first face 254 and a second face 255. The central aperture 253 is adapted to receive and mount two roller bearings 267 side by side therein. A first trilobate recess 256a is formed in the body 251 which extends from the first face 254 and a second trilobate recess 256b is formed in the body 251 which extends from the second face 255. The trilobate recesses 256a and 256b are identical to the trilobate recess 56 of the cam gear 50, and both include a trilobate internal cam surface 257 and a trilobate external cam surface 258. The trilobate recesses 256a and 256b are axially out of phase with each other by an angle of 60[deg.]. The body 251 can also include apertures 259 and/or recesses 245 to lighten/balance its weight as desired.

The engine 230 thus comprises an output shaft 32, a front drive gear 40a, a front cam gear 50a, a first set 270 of first and second piston assemblies 60 and 70 and a central cam 80, the coupling cam gear 250a, a second set 272 of first and second piston assemblies 60 and 70 and a central cam 80, a rear cam gear 50b and a rear drive gear 40b. The bearings 136b and 146b in the first set 270 engage the first trilobate recess 256a and the bearings 136a and 146a in the second set 272 engage the second trilobate recess 256b. Thus, the first and second sets 270 and 272 are coupled to each other and the pair of first piston assemblies 60 reciprocates in out of phase opposing directions. Similarly, the pair of second piston assemblies 70 reciprocates in out of phase opposing directions. This assists in balancing the moving mass in the engine 230. As with the engine 30, the drive gears 40a and 40b and the two central cams 80 are all axially fixed to the shaft 32 and rotatable therewith, whilst the cam gears 50a and 50b and the coupling cam gear 250a are coupled and rotatable in an opposite direction to the shaft 32. A differential gearing assembly couples the drive gears 40a and 40b, cam gears 50a and 50b, and coupling cam gear 250a together.

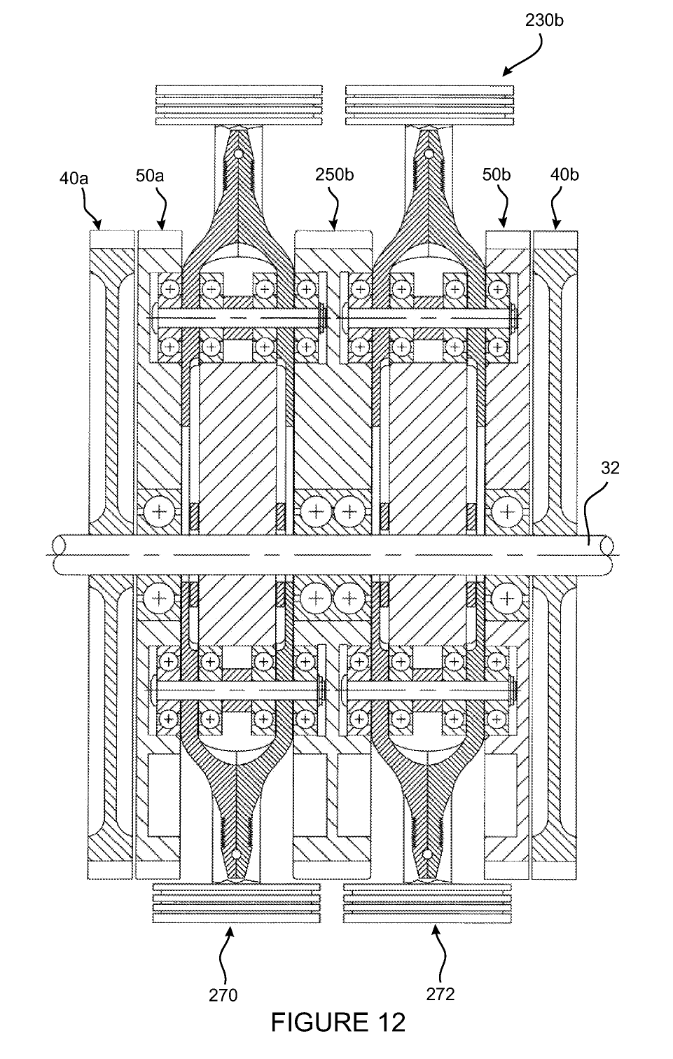

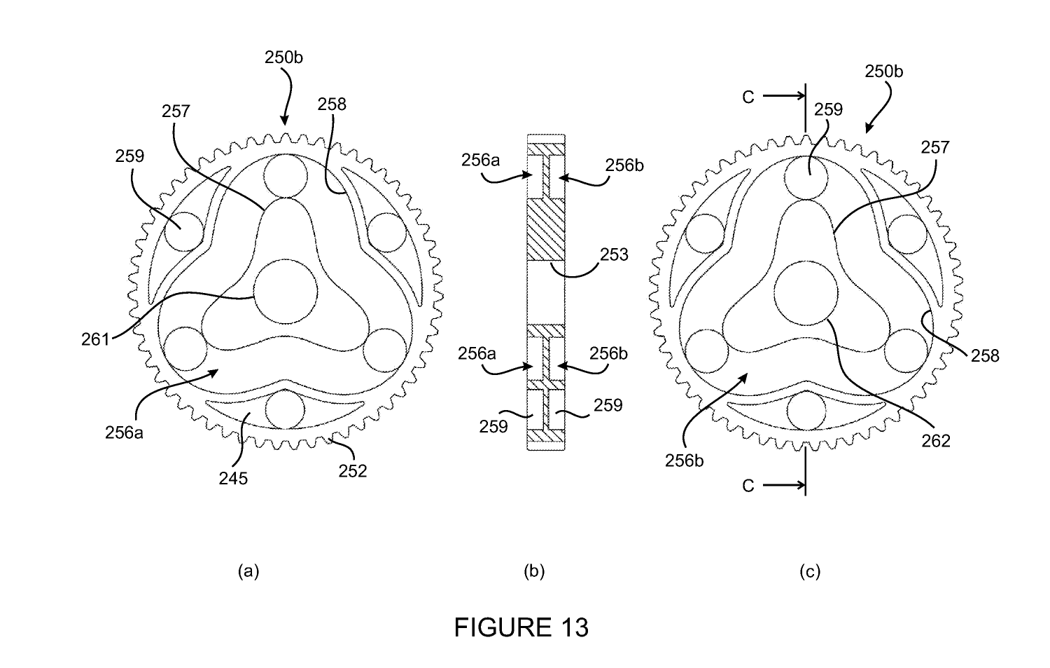

FIG. 12 shows an engine 230b, which is a modified version of the engine 230. Engine 230b uses a coupling cam gear 250b (see FIG. 13) which is similar to the coupling cam gear 250a, except that first and second trilobate recesses 256a and 256b are aligned and in phase with each other. Thus, the pair of first piston assemblies 60 reciprocates together and the pair of second piston assemblies 70 also reciprocates together.

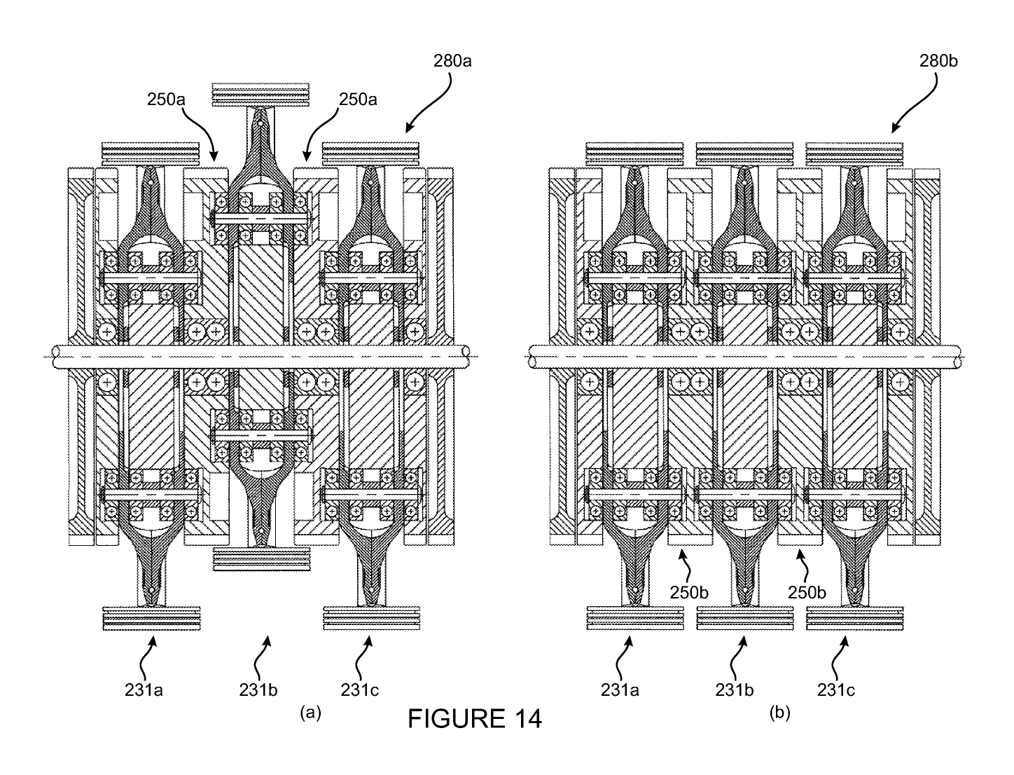

FIG. 14 (a) shows an engine 280a having three banks 231a, 231b and 231c side by side, coupled by a coupling cam gear 250a between each bank. Thus, the adjacent pairs of piston assemblies reciprocate in opposing directions.

FIG. 14 (b) shows an engine 280b which is a modification of the engine 280a, using the coupling cam gear 250b to couple the adjacent banks. Thus, the adjacent pairs of piston assemblies reciprocate together.

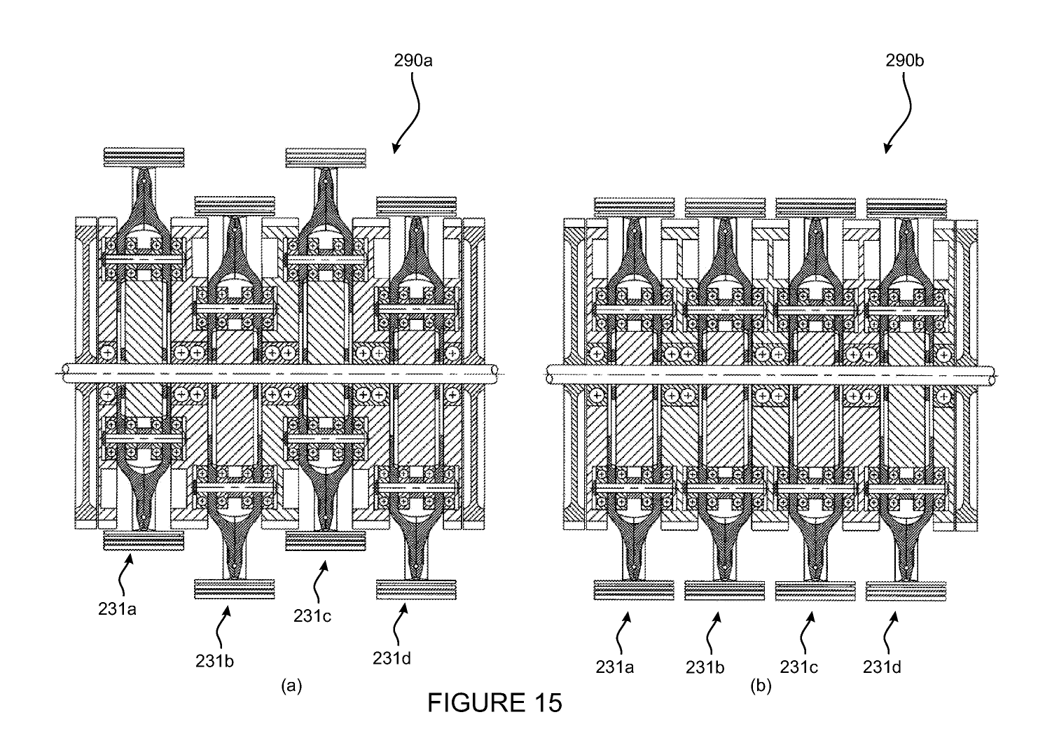

FIG. 15 (a) shows an engine 290a similar to the engine 280a but having four banks 231a to 231d, and FIG. 15 (b) shows an engine 290b similar to the engine 280b but also having four banks 231a to 231d. The present embodiments thus provide engines with advantages over the existing internal combustion engines and improvements over the engines in WO 2008/028252 and WO 97/04225.

As the rotational mass around the shaft is increased by the cam gears and the drive gears, the Brake Specific Fuel Consumption (BSFC) is improved. The multilobate cam gears provide a gear. Also, they provide internal and external trilobate cam profiles which the bearings follow, which substantially reduces torsional twisting in the pistons. Further, as the cam surfaces wear, the bearings will still be substantially in contact with the cam profiles.

In the engines of WO 2008/028252 and WO 97/04225, the pistons each have two bearings per piston in contact two multilobate cam surfaces. In the present embodiments, the engines have three bearings per piston in contact with five multilobate cams at any given time, which improves power transfer and reducing the twisting and torsional force in the pistons.

A (second) piston opposite a (first) piston in the power stroke adds to torque as the lateral bearings of the second piston engage the trilobate external cam surface 58 of the cam gears, from BDC to TDC of the second piston (TDC to BDC of first piston in the power stroke). The second piston is better contained and aids rotation of the shaft.

In the first piston assembly 60, by having two identical halves which can be re-attached to each other via the pistons, allows the first piston assembly to be assembled with the second piston assembly 70 located within its space 68.

The configuration of the piston assemblies make the pistons simpler, easier to manufacture, lighter and more easily assembled.

As described in WO/9704225 and WO/2008/028252 A1, the present engine can have central cams and cam gears of three, five or seven lobes or any odd number above three. With different number lobed cams a different X configuration angle is provided for the piston assemblies. It is however clear that the engine can also work with even numbers of lobes.

It is also to be noted that the banks in the engines shown in FIGS. 10 to 15 can be arranged inline at 0[deg.] to each other or can be arranged out of phase by any angle.

The teeth in the cam gears and drive gears can also be cut internally rather than externally as shown.

The preferred embodiments thus provide a number of advantages, including one or more of the following:

Substantially eliminating twisting of pistons;

Eliminating the need for elaborate slide ways and associated parts on the piston;

The (second) piston opposite the (first) piston in the power stroke adds to torque as the bearings of the second piston engage the trilobate external cam 58 of the cam gears, from BDC to TDC of the second piston (TDC to BDC of first piston in the power stroke); Increase in mass around the shaft adds to torque at high revolution speeds and the mass is contained to an ideal area, the cam gears also double as flywheels and therefore provide better momentum;

Less reciprocating mass as pistons and associated connector members between them are lighter;

Easier and cheaper to manufacture;

More durable;

Banks of 2 or more (8, 12, 16 etc. pistons) can be easily linked using the coupling cam gear 250 or 250b;

Improved brake specific fuel consumption (BSFC) and efficiency;

The outer perimeter of the cam gears are gear cut to aid in the transfer of power to the output shaft, which also allows banks of cylinders to be easily connectable and power transfer simplified;

The large gear in the front of the engine in WO 2008/028252 becomes obsolete or can be used in coordination with a series of differential gearing to generate rotational forces through the output shaft reducing nonproductive weight of engine & assembly;

With the slideways of WO 2008/028252 being obsolete, this lessens obstruction for splash feed of oil to underside of the pistons;

Differential gearing can be used to remove or minimise backlash in the gearing assembly;

Lateral bearings can be totally self-contained;

Equal distribution of load;

Improved radial and dynamic balance;

Finds optimum (‘sweet spot’) naturally; Reciprocating load being better displaced; and

Improved piston design, making it easier and simpler to manufacture and assemble.

It is clear that modifications can be made to the above embodiments or that the invention can be embodied in other forms. For example, one broad form of the invention provides an engine having the central cam only received within the space in one of the piston assemblies. This engine for example can be used as a two-stroke engine. Also, the external cam surfaces in the cam gears can be omitted. In another embodiment, the central cam can be omitted, with one of the cam gears axially fixed to the shaft and the other being differentially geared thereto for counter-rotation around the shaft. This is similar to the engine in WO 2008/028252, but with the additional feature of having the external cam surface in the multilobate recesses, and the additional advantages provided thereby.

Also, the engine 30 or each bank in the engines 230, 280 and 290 can have three or more piston assemblies associated therewith. The bearing pair 135 can alternatively be replaced by a single wider bearing. One of the drive gears 40 can also be omitted from the engine.

The lateral bearing engaging the first and second (inner and outer) cam surfaces of the cam gears and the coupling cam can alternatively comprise a separate cam follower engaging a respective one of the first and second lateral cam and coupling cam surfaces.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### DIFFERENT INSTANCES OF OBJECTS

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### SPECIFIC DETAILS

In the description provided herein, numerous specific details are set forth. However, it is understood that embodiments of the invention may be practiced without these specific details. In other instances, well-known methods, structures and techniques have not been shown in detail in order not to obscure an understanding of this description.

### TERMINOLOGY

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### COMPRISING AND INCLUDING

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to industries related to engines, pumps, road and rail vehicles, aircraft, and industrial manufacturing.

1-63. (canceled)

64. An internal combustion engine comprising:
a shaft;
a multilobate central cam fixed to the shaft, the central cam comprising at least three lobes which define a central cam surface;
at least one cylinder module, each cylinder module comprising:
a pair of cylinders, the cylinders being diametrically opposed with respect to the shaft with the central cam interposed therebetween;
a piston in each cylinder, each piston comprising an associated engagement means for engaging the central cam surface; and
a connecting member connecting the pistons, the connecting member comprising an internal space through which the central cam extends; and
wherein reciprocating motion of the pistons in the cylinders in use imparts rotary motion to the shaft via engagement of the engagement means of the pistons with the central cam surface of the central cam.

65. The internal combustion engine of claim 64 further comprising two multilobate lateral cams disposed on opposite sides of the central cam and differentially geared to the central cam for counter rotation about the shaft.

66. The internal combustion engine of claim 65 wherein each lateral cam comprises a multilobate first lateral cam surface and a multilobate second lateral cam surface axially spaced from the first lateral cam surface, wherein both the first and second lateral cam surfaces are engaged by the corresponding engagement means associated with each piston.

67. The internal combustion engine of claim 66 wherein the first and second lateral cam surfaces of each lateral cam are defined by a multilobate recess formed in the respective lateral cam.

68. The internal combustion engine of claim 65 further comprising at least one drive gear fixed to the shaft, wherein at least one of the lateral cams is differentially geared to the at least one drive gear.

69. The internal combustion engine of claim 64 wherein the engagement means associated with each piston comprises at least one roller bearing follower.

70. The internal combustion engine of claim 64 wherein the connecting member comprises threaded end portions, and each piston comprises a threaded formation for attachment to a respective end portion of the connecting member.

71. The internal combustion engine of claim 64 wherein the connecting member is split into first and second longitudinal sections, wherein the first and second sections are held together by the pistons when the pistons are attached to end portions of the connecting member.

72. An internal combustion engine comprising:
a shaft;
a multilobate central cam fixed to the shaft, the central cam comprising at least three lobes which define a central cam surface;
two multilobate lateral cams disposed on opposite sides of the central cam, the lateral cams having the same number of lobes as the central cam, the lateral cams differentially geared to the central cam for counter rotation therewith about the shaft, each lateral cam defining a first lateral cam surface;
two cylinder modules, each cylinder module comprising:
a pair of cylinders, the cylinders being diametrically opposed with respect to the shaft with the central and lateral cams interposed therebetween;
a piston in each cylinder, each piston comprising an associated engagement means for engaging the central cam surface and the first lateral cam surfaces; and
a connecting member connecting the pistons, the connecting member comprising an internal space through which the central cam extends; and
wherein reciprocating motion of the pistons in the cylinders in use imparts rotary motion to the shaft via engagement of the engagement means of the pistons with the cam surfaces of the central and lateral cams.

73. The internal combustion engine of claim 72 wherein each lateral cam further comprises a second lateral cam surface axially spaced from the first lateral cam surface, wherein both first and second lateral cam surfaces are engaged by the corresponding engagement means associated with each piston.

74. The internal combustion engine of claim 72 further comprising two drive gears fixed to the shaft and disposed adjacent a respective lateral cam, wherein the lateral cams are differentially geared to the drive gears.

75. An internal combustion engine comprising:
a shaft;
at least two cylinder banks, each cylinder bank comprising:
a multilobate central cam fixed to the shaft, the central cam comprising at least three lobes which define a central cam surface;
at least one cylinder module, each cylinder module comprising:
a pair of cylinders, the cylinders being diametrically opposed with respect to the shaft with the central cam interposed therebetween;
a piston in each cylinder; and
a connecting member connecting the pistons,
a coupling cam disposed between each bank, each coupling cam differentially geared to the central cams for counter rotation about the shaft, each coupling cam defining a multilobate first coupling cam surface on each of opposing sides thereof;
wherein each piston comprises an associated engagement means for engaging the central cam surface and a first coupling cam surface of its adjacent coupling cam;
wherein reciprocating motion of the pistons in the cylinders in use imparts rotary motion to the shaft via engagement of the engagement means of the pistons with the central cam surfaces and the first coupling cam surfaces.

76. The internal combustion engine of claim 75 wherein each connecting member comprises an internal space through which the respective central cam extends;

77. The internal combustion engine of claim 75 further comprising a multilobate lateral cam for each endmost bank, the lateral cams differentially geared to the central cams for counter rotation about the shaft, wherein each lateral cam comprises a multilobate first lateral cam surface and a second lateral cam surface axially spaced from the first lateral cam surface, wherein both the first and second lateral cam surfaces are engaged by the corresponding engagement means associated with the respective piston.

78. The internal combustion engine of claim 77 wherein the engagement means associated with each piston comprises a separate cam follower engaging a respective one of the first and second lateral cam surfaces.

79. The internal combustion engine of claim 75 wherein the opposing sides of each coupling cam comprises a second multilobate coupling cam surface axially spaced from the first coupling cam surface, wherein both the first and second coupling cam surfaces are engaged by the corresponding engagement means associated with the respective piston.

80. The internal combustion engine of claim 79 wherein the engagement means associated with each piston comprises a separate cam follower engaging a respective one of the first and second coupling cam surfaces.

81. The internal combustion engine of claim 75 wherein the first coupling cam surfaces on the opposing sides of the coupling cam are axially out of phase with each other by 60° or aligned with each other.

82. The internal combustion engine of claim 75 further comprising a drive gear for each endmost bank, the drive gears fixed to the shaft, wherein each coupling cam is differentially geared to the drive gears.

83. The internal combustion engine of claim 75 wherein the banks are phased inline at 0° to each other or out of phase by any angle.
